(19) United States
(12) Patent Application Publication
(10) Pub. No.: US 2009/0092879 A1
(43) Pub. Date: Apr. 9, 2009

(54) Fuel Cells with Sputter Deposited Pt and Pt Alloy Electrodes

(76) Inventors: Eric Rolland KREIDLER, Pickerington, OH (US); Ting HE, Dublin, OH (US)

Correspondence Address: Capitol IP, PLLC, 113 S. Columbus St., Suite 311, Alexandria, VA, 22314, US

(21) Appl. No.: 12/244,809

(22) Filed: Oct. 3, 2008

Related U.S. Application Data
(60) Provisional application No. 60/977,853, filed on Oct. 5, 2007.

(51) Int. Cl. H01M 8/10

(52) U.S. Cl. 429/30; 156/150

(57) ABSTRACT

The present application is directed to a fabrication method to reduce Pt loading in fuel cells through the use of thin film electrodes by increasing Pt utilization and the use of more active Pt alloys that can be easily and inexpensively fabricated by sputter deposition. Pt and Pt alloy thin films were sputter deposited onto carbon/Nafion® decals and subsequently hot pressed with the catalyst thin film towards the membrane. The results show improved mass performance and catalyst utilization with Pt thin films and increased mass activities can be achieved with PtCo (76:24 atomic ratio) and PtCr (80:20 atomic ratio) as compared to pure Pt. Mass activity improvements of 14 mV and 8 mV were observed for the PtCo and PtCr alloys with respect to a pure Pt film with similar mass loading under 300/350 kPa hydrogen/oxygen operation.

### RELATED APPLICATIONS

The present application claims benefit from earlier filed U.S. Provisional Application No. 60/977,853, filed Oct. 5, 2007, which is incorporated herein in its entirety by reference for all purposes.

### BACKGROUND

1. Field of the Invention

The present teachings relate to a method of preparing a membrane thin film electrode assembly. A composition of a support material and an ionomer component is dried on a carrier film, a metal or metal alloy is sputtered onto the dried composition, and a decal with the film of dispersed metal or metal alloy is removed from the carrier film. The decal has a first face of dried composition and a second face of the film of dispersed metal or metal alloy. A polymer electrolyte membrane is provided and the film of dispersed metal or metal alloy on the decal can be contacted to a face of the polymer electrolyte membrane, and then the decal can be hot pressed onto the polymer electrolyte membrane to form the desired membrane thin film electrode assembly.

The present teachings also relate to a thin film electrocatalyst featuring a decal made of a composition of a support material and an ionomer component, and a thin film of a metal or metal alloy catalyst sputtered onto that composition, and a polymer electrolyte membrane. The thin film of a metal or metal alloy sputtered onto the composition can be in direct contact with the polymer electrolyte membrane.

2. Discussion of the Related Art

Proton exchange membrane fuel cells (hereinafter “PEMFC”) have attracted great interest as alternative power sources in stationary and mobile applications as a result of good energy conversion efficiencies, low green-house gas emissions, and low operating temperatures. Currently, large scale implementation of PEMFCs is inhibited due to high material costs and poor long term performance durability. A significant portion of the cost and durability issues can be attributed to the cathode oxygen reduction catalyst which requires a significantly high loading of platinum (Pt, currently on the order of 0.4 mg/cm²) to overcome the sluggish kinetics of the oxygen reduction reaction at operating temperatures. Furthermore, studies have shown that Pt nanoparticle coarsening and carbon corrosion in the cathode lead to performance losses with time. See, for instance, S. Ye, M. Hall, H. Cao, and P. He, ECS Trans. 3 (1), 657 (2006), L. Roen, C. Paik, T. Jarvi, Electrochem. and Sol. State Letters 7 (1), A19 (2004), R. Borup, J. Davey, F. Garzon, D. Wood, M. Inbody, J. Power Sources 163, 76 (2006), H. Colón-Mercado, B. Popov, J. Power Sources 155, 253 (2006), M. Cai, M. Ruthkosky, B. Merzougiu, S. Swathirajin, M. Bologh, S. Oh, J. Power Sources 160, 977 (2006), and J. Ferreira, G. O', Y. Shao-Hom, D. Morgan, R. Makharia, S. Kocha, H. Gasteiger, J. Electrochem. Soc. 152 (11), A2256 (2005).

As a result, a considerable amount of research has been performed to reduce the Pt loading and improve the stability of cathode catalysts in PEMFCs without sacrificing performance.

A major emphasis has been placed on the discovery of more active Pt alloys towards the catalytic electroreduction of oxygen to achieve lower Pt loadings and improved stability. We have previously reported a high throughput method based on the physical vapor deposition of thin Pt alloy films where several candidate alloys were identified as having improved catalytic activity towards oxygen reduction. See T. He, E. Kreidler, L. Xiong, J. Luo and C. J. Zhong, J. Electrochem. Soc. 153 (9), A1637 (2006), and T. He, E. Kreidler, L. Xiong and E. Ding, J. Power Sources, 165, 87 (2007).

The development of traditional carbon supported alloy nanoparticles is extremely time consuming with different alloy compositions often requiring different fabrication techniques to achieve desired alloy particle size, micro-composition uniformity, and nanoparticle dispersion. See T. He, in Recent Advances in Solution-based Chemical Synthesis of Semiconductor, Metal, and Oxide Nanocrystals, P. D. Cozzoli, Editor, Research Signpost, in press. The use of thin film technology offers the ability to easily and inexpensively fabricate membrane electrode assembly (hereinafter “MEA”) electrocatalyst solid solution structures with good compositional control and reduced Pt loading.

The possibility of using thin film electrocatalyst layers in PEMFCs has been reported by several research groups. See, for instance, S. Cha and W. Lee, J. Electrochem. Soc. 146 (11), 4055 (1999), R. O'Hayre, S. Lee, S. Cha, F. Prinz, J. Power Sources 109, 483 (2002), S. Hirono, J. Kim, and S. Srinivasan, Electrochem. Acta 42 (10), 1587 (1997), A. Haug, R. White, J. Weidner, W. Huang, S. Shi, T. Stoner, N. Rana, J. Electrochem. Soc. 149 (3), A280 (2002), A. Gulla, M. Saha, R. Allen, S. Mukerjee, Electrochem. and Sol State Letters 8 (10), A504 (2005), M. Saha, A. Gulla, R. Allen, S. Mukerjee, Electrochem. Acta 51, 4680 (2006), T. Nakakubo, M. Shibata, and K. Yasuda, J. Electrochem. Soc. 152 (12), A2316 (2005), and A. Gulla, M. Saha, R. Allen, S. Mukerjee, J. Electrochem. Soc. 153 (2), A366 (2006). The work in the above-identified publications has included direct deposition of Pt onto proton exchange membranes, gas diffusion layers, PTFE transfer sheets, plus alternating layers of Pt and carbon/Nafion® inks, and layered metal depositions on gas diffusion layers. The main focus of the work performed to date has been the reduction of Pt loading by increasing the Pt utilization within the electrocatalyst layer. While performance comparable to powder based electrocatalysts has yet to be achieved, excellent power density to Pt loading ratios have been demonstrated.

Additionally, thin film electrocatalysts have been fabricated whereby Pt and alloy films were deposited on crystalline organic whiskers and transferred to the surface of a membrane, see M. Debe, in Handbook of Fuel Cells—Fundamentals Technology and Applications, W. Vielstich, A. Lamm, H. Gasteiger, editors, Vol. 3, Ch. 45, John Wiley and Sons (2003), and A. Bonakdarpour, R. Lobel, R. Atanasoski, G. Vernstrom, A. Schmoeckel, M. Debe, J. Dahn, J. Electrochem. Soc. 153 (10), A1835 (2006). These thin film coated whiskers have been tested in operational fuel cells under various operating conditions to ascertain activity and stability.

A need exists for methods of preparing MEAs with relatively low Pt or Pt alloy loadings which also provide high levels of performance. The present disclosure is directed to methods of physical vapor deposition of Pt and Pt alloys, and assembly of MEAs as a viable method of producing higher performance or lower cost electrocatalyst materials.

### SUMMARY

The present teachings are directed to a method of preparing a membrane thin film electrode assembly by providing a composition of a support material and an ionomer component, and a carrier film substrate including at least two faces; the composition can then be applied onto at least one face of the carrier film substrate, and dried to provide a dried composition. A metal or metal alloy can be sputtered onto the dried composition to provide a film of dispersed metal or metal alloy. Then a decal having one first face of dried composition and another face of the film of dispersed metal or metal alloy can be removed from the one face of the carrier film substrate. The film of dispersed metal or metal alloy on the decal is then contacted with a first face of the polymer electrolyte membrane, and the decal is hot pressed onto the polymer electrolyte membrane to form a membrane thin film electrode assembly.

The second face of the polymer electrolyte membrane can then be contacted with a gas diffusion electrode and a gas diffusion layer can be contacted with the first face of the decal, followed by hot pressing of the gas diffusion electrode to the second face of the polymer electrolyte membrane to form a full cell membrane thin film electrode assembly.

Also disclosed by the present disclosure is a thin film electrocatalyst featuring a decal made up of a composition of a support material and an ionomer component, and a thin film of a metal or metal alloy catalyst sputtered onto the composition; and a polymer electrolyte membrane, with the thin film of a metal or metal alloy in direct contact with the polymer electrolyte membrane.

Further disclosed herein is a membrane electrode assembly having a polymer electrolyte membrane having a first face and a second opposing face, with a gas diffusion electrode in contact with the first face of the polymer electrolyte membrane, and a thin film electrode in contact with the second face of the polymer electrolyte membrane. The thin film electrode can be sandwiched between the second face of the polymer electrolyte membrane and a gas diffusion layer, and the thin film electrode includes a decal of a composition made of a support material and an ionomer component, a thin film of a metal or metal alloy catalyst can be sputtered onto the composition; and the thin film of a metal or metal alloy catalyst can be in direct contact with the second face of the polymer electrolyte membrane.

### BRIEF DESCRIPTION OF THE DRAWINGS

The accompanying drawings which are included to provide a further understanding of the present disclosure and are incorporated in and constitute a part of this specification, illustrate various embodiments of the present disclosure and together with the detailed description serve to explain the principles of the present disclosure. In the drawings:

FIGS. 1(a) and (b) are graphs of voltage versus current density of the high pressure (300/350 KPa) performance of thin Pt catalyst layers with various Pt loadings under (a) hydrogen/air and (b) hydrogen/oxygen conditions;

FIGS. 2(a) and (b) are Tafel plots for the polarization curves shown in FIGS. 1(a) and (b) under (a) hydrogen/air and (b) hydrogen/oxygen operation;

FIG. 3 is a graph of the mass performance of thin Pt cathode films in comparison to a traditional carbon supported Pt cathode under 150 kPa hydrogen/oxygen operation at differing metal loadings;

FIG. 4 is a graph of the mass performance of PtCo (♦) and PtCr (▴) alloys with pure Pt (□) under 300/350 kPa (a) hydrogen/air (left) and (b) hydrogen/oxygen (right) operation, respectively, and

FIG. 5 is a schematic diagram of a production method according to the present disclosure of both full and half cell assemblies.

### DETAILED DESCRIPTION

A method of preparing a membrane thin film electrode assembly is taught by the present disclosure. The method includes providing a composition comprising a support material and an ionomer component, and also a carrier film substrate having at least two faces. The composition can be applied onto at least one face of the carrier film substrate, and then dried to provide a dried composition onto which a metal or metal alloy can be sputtered to provide a film of dispersed metal or metal alloy. A decal can be removed from the one face of the carrier film substrate. The decal has a first face of dried composition and a second face of the film of dispersed metal or metal alloy. A polymer electrolyte membrane with two opposing faces is provided and the second face of the film of dispersed metal or metal alloy on the decal can be contacted to a first face of the polymer electrolyte membrane, and then the decal can be hot pressed onto the polymer electrolyte membrane to form the desired membrane thin film electrode assembly.

The presently disclosed method further includes providing a gas diffusion layer and a gas diffusion electrode, and contacting the gas diffusion layer with the first face of the decal, that is, the face composed of the dried composition of a support material and an ionomer component. The gas diffusion electrode can be contacted to the second face of the polymer electrolyte membrane, and then by hot pressing the gas diffusion electrode to the second face of the polymer electrolyte membrane the desired full cell membrane thin film electrode assembly can be formed.

For the present method, the sputtering of the metal or metal alloy can occur at pressures greater than about 10 mTorr Ar, in some cases at pressures greater than about 50 mTorr Ar, and in some other cases at pressures greater than about 75 mTorr Ar.

A suitable support material for the present method can be carbon black. The ionomer component can include at least one member selected from the group consisting of perfluorocarbon sulfonic acidic polymer, perfluorocarbon phosphonic acidic polymer, and trifluorostyrene sulfonic acidic polymer, for instance. The ionomer component can be any binder suitable for use in a typical fuel cell operating environment, and providing adequate binding capacity of the support material, one of skill in the art will recognize suitable binder materials.

Suitable metals for the presently disclosed method include at least one member selected from the group consisting of iron, cobalt, nickel, copper, ruthenium, rhodium, palladium, silver, and platinum. Suitable metal alloys can include a mixture of platinum and at least one member selected from the group consisting of titanium, vanadium, chromium, manganese, iron, cobalt, nickel, copper, zinc, selenium, molybdenum, ruthenium, rhodium, palladium, silver, tungsten, rhenium, iridium, and gold.

An example of a suitable metal alloy would include platinum and at least one member selected from the group consisting of chromium and cobalt. Platinum by itself is also a suitable catalyst metal for the present method.

In the hot pressing process of the present method, the decal and the polymer electrolyte membrane can be exposed to temperatures ranging between about 90 to 150 C and loads ranging between about 30 to 50 MPa. For the hot pressing of the gas diffusion electrode and the polymer electrolyte membrane, the exposure can be to temperatures ranging between about 90 to 150 C and loads ranging between about 30 to 50 MPa.

Some suitable carrier film substrates for this method include silicone coated Mylar®, expanded porous polytetrafluoroethylene, porous polyethylene, porous polypropylene, non-porous ethylene tetrafluoroethylene, polytetrafluoroethylene, and polyethylene terephthalate.

The present disclosure also includes a thin film electrocatalyst featuring a decal made of a composition of a support material and an ionomer component, and a thin film of a metal or metal alloy catalyst sputtered onto that composition, and a polymer electrolyte membrane. The thin film of a metal or metal alloy sputtered onto the composition can be in direct contact with the polymer electrolyte membrane.

A membrane electrode assembly including a polymer electrolyte membrane comprising a first face and a second opposing face, a gas diffusion electrode, a thin film electrode, and a gas diffusion layer is also set forth by this disclosure. The gas diffusion electrode can be in contact with the first face of the polymer electrolyte membrane, and the thin film electrode can be in contact with the second face of the polymer electrolyte membrane, with the thin film electrode sandwiched between the second face of the polymer electrolyte membrane and the gas diffusion layer. The thin film electrode is made of a decal of a composition of a support material and an ionomer component, and a thin film of a metal or metal alloy catalyst sputtered onto the composition; and the thin film of a metal or metal alloy catalyst is in direct contact with the second face of the polymer electrolyte membrane.

Examples of a suitable support material include carbon black. Suitable examples of the ionomer component include at least one member selected from the group consisting of perfluorocarbon sulfonic acidic polymer, perfluorocarbon phosphonic acidic polymer, and trifluorostyrene sulfonic acidic polymer.

For the membrane electrode assembly presently taught herein, the metal can include at least one member selected from the group consisting of iron, cobalt, nickel, copper, ruthenium, rhodium, palladium, silver, and platinum. Platinum is one preferred metal although the expense associated therewith can be prohibitive. Metal alloys that can be utilized in the present membrane electrode assembly include alloys of platinum and at least one member selected from the group consisting of titanium, vanadium, chromium, manganese, iron, cobalt, nickel, copper, zinc, selenium, molybdenum, ruthenium, rhodium, palladium, silver, tungsten, rhenium, iridium, and gold. Some notable platinum alloys include alloys with chromium and cobalt, individually and severally.

The thin film cathode electrocatalyst layers according to the present disclosure can be fabricated by physical vapor deposition of Pt and Pt-containing alloys onto carbon/Nafion® decals which were then hot pressed with the catalyst film towards the membrane. The performance of these thin catalyst films towards oxygen electroreduction were measured in an operational fuel cell see if reductions in Pt loading by increasing Pt utilization and utilizing more active Pt alloys can be easily produced by using the thin film preparation method presently disclosed.

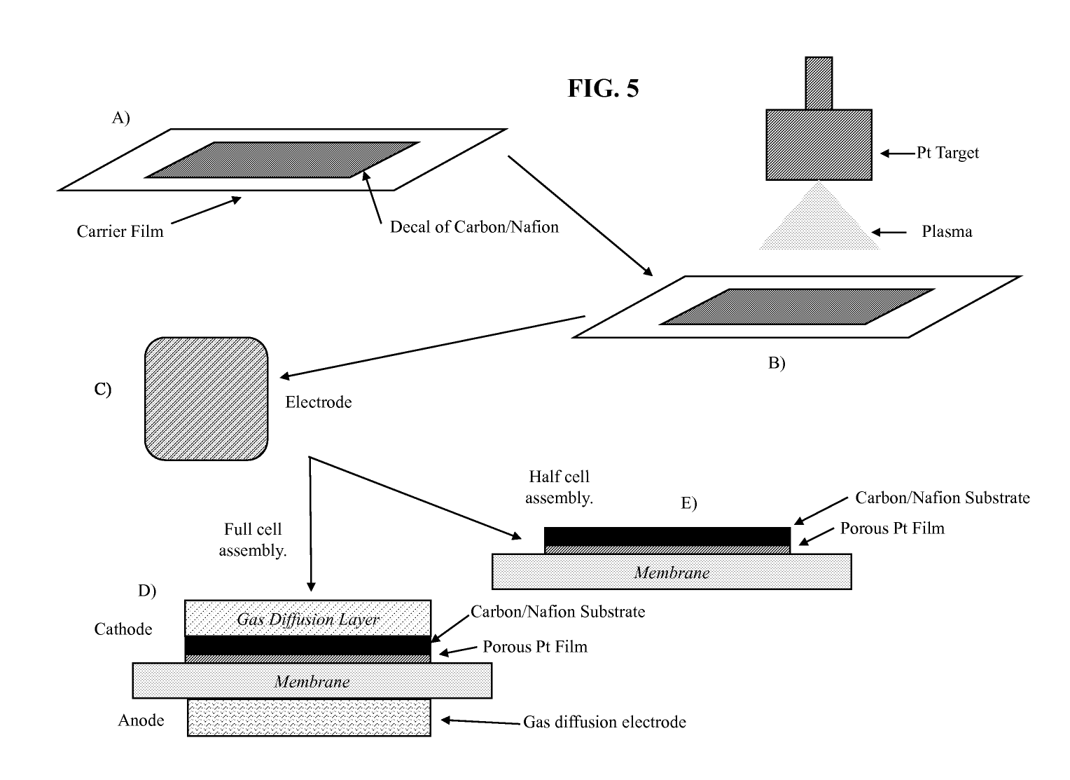

As shown in FIG. 5, a composition containing a support material, such as carbon, is mixed with Nafion® ink and mechanically cast onto carrier film, for instance, silicone coated Mylar. This step A) can produce a uniform substrate with a controllable thickness of the support material. In step B), platinum can be deposited by physical deposition onto the surface of the decal. Target power, deposition time, and deposition pressure are controlled to achieve desired film porosity and catalyst loading. Then, in step C), the electrode can be cut from the carrier film. The electrode is then positioned, with the catalyst side in contact with the polymer electrode membrane, to form either a full cell (shown at D) or half cell (shown at E) assembly. Other structures and arrangements of the components shown in FIG. 5 are also possible.

In some embodiments of the present teachings, a decal can be applied to both faces of the polymer electrode membrane, and thus eliminate the need for a gas diffusion electrode positioned on one side of the membrane. Alternatively, one or both faces of the MEA can be feature the thin film electrodes of the present disclosure in combination with gas diffusion layers.

### EXAMPLES

### Experimental Procedure

### 1. Preparation of Carbon/Nafion® Decals

Carbon/Nafion® decal were made by casting carbon/Nafion® ink onto silicone coated Mylar® using a K Paint Applicator (R K Print Coat Instruments Ltd.). The carbon/Nafion® ink was formulated by mixing Vulcan XC72R carbon (Cabot), diluted Nafion® (5 wt %, Aldrich), and 1-propanol (Fisher) to achieve a carbon to Nafion® ratio of 4 to 1 by weight in the dry decal. The decal was dried under ambient conditions and the final thickness was about 10 μm.

### 2. Deposition of Catalyst Films

Thin catalyst films were deposited onto the exposed surface of the decals prepared above by using a Kurt J. Lesker CMS-18 physical vapor deposition system at relatively high pressure (75 mTorr Ar) and at low target powers to enhance film porosity. The substrate was rotated to achieve good film thickness uniformity and all depositions were performed at room temperature.

For pure platinum cathode electrocatalyst films, the platinum target power was held at 30 W and loading was controlled by varying deposition time. The PtCo and PtCr alloys were fabricated by co-sputtering Co and Cr with Pt to form alloy solid solutions. Alloy compositions were controlled by varying the Co and Cr target powers while holding the Pt target power constant at 30 W. Alloy loadings were controlled by varying deposition time.

Thin film compositions and metal loadings were determined using a Varian inductively coupled plasma—optical emission spectroscopy (ICP-OES). Table I lists the deposition parameters and ICP-OES results for each of the reported cathode electrocatalyst films.

### 3. Preparation of Membrane Electrode Assemblies

MEAs were fabricated by hot-pressing the decal with the catalyst film towards the polymer electrolyte membrane, such as a Nafion® membrane (NRE-212, DuPont), at a temperature of 110° C. with loads between 34 and 42 MPa for 2 minutes.

The polymer electrolyte membrane can be formed from a polymer electrolyte, and in particular, the polymer electrolyte, in which a fluoropolymer has at least part of the polymer skeleton being fluorinated or hydrocarbon polymer containing no fluorine in the polymer skeleton, is preferably provided with an ion exchange group. The types of the ion exchange group are not limited, although they are appropriately selected according to the specific application. For example, a polymer electrolyte, which is provided with at least one ion exchange group such as sulfonic acid, carboxylic acid, phosphonic acid, and others known to those of skill in the art, can be used.

A fluoropolymer electrolyte in which at least part of the polymer skeleton is fluorinated, as a polymer electrolyte provided with an ion exchange group, a perfluorocarbon sulfonic acidic polymer such as Nafion®, perfluorocarbon phosphonic acidic polymer, trifluorostyrene sulfonic acidic polymer, and others known to those of skill in the art. Among these, Nafion® is preferably used.

A hydrocarbonic polymer, in which no fluoride is contained, as a polymer electrolyte provided with an ion exchange group, specifically can include polysulfonic acid, polyarylether ketone sulfonic acid, polybenzimidazolen alkylphosphonic acid, and others known to those of skill in the art.

Gas diffusion electrodes (GDE) for instance, an E-TEK LT-120E-w/StdN, with a loading of 0.5 mg Pt/cm² was utilized on the anode side. An E-TEK LT-1200W gas diffusion layer (GDL) was utilized on the cathode side in conjunction with the decal. The GDE and GDL were concurrently hot pressed at 110° C. with loads between 34 and 42 MPa for 2 minutes. The assembled MEA was loaded in a single cell fixture with a single channel co-flow design (Fuel Cell Technologies, Inc.). All testing was performed on a Teledyne 890C Fuel Cell Test System.

### 4. Evaluation of MEAs

The performance of the MEAs were evaluated at a cell temperature of 70° C., and with anode and cathode humidifier temperatures of 70° C. and 65° C., respectively. The anode and cathode gas flows were held constant at stoichiometries of 1.5/2.0 at 1000 mA/cm².

Four different testing conditions were utilized:

(i) hydrogen/air operation at 150/150 kPa back pressures;

(ii) hydrogen/air operation at 300/350 kPa back pressures;

(iii) hydrogen/oxygen operation at 150/150 kPa back pressures; and

(iv) hydrogen/oxygen operation at 300/350 kPa back pressures.

MEA conditioning was performed overnight under hydrogen/air operation at 150/150 kPa back pressure at 400 mV. Several hours of equilibration time were allotted between each condition before testing. MEA testing was conducted at each of the aforementioned conditions by repeating consecutive polarization curves (between 50 and 100+ cycles) until stable curves were achieved.

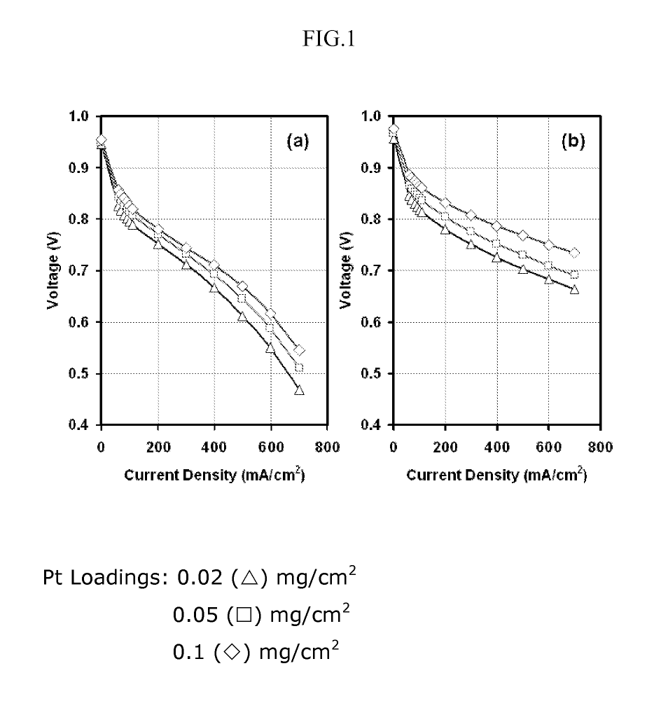

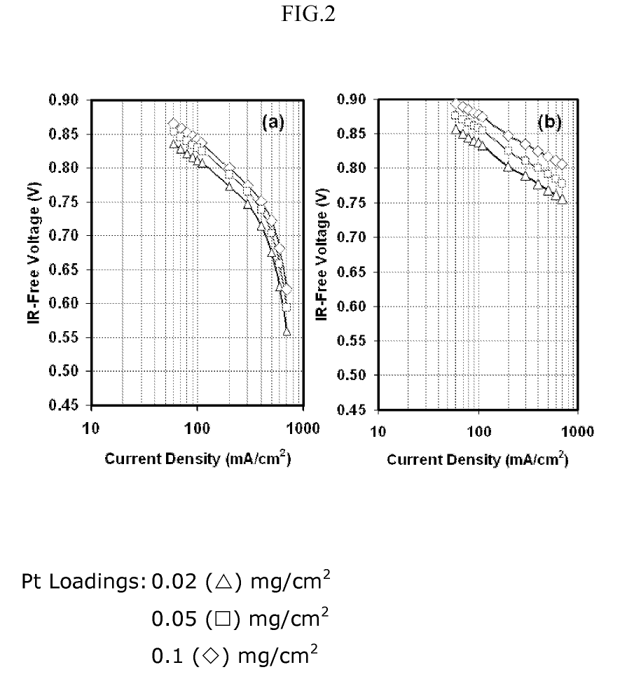

FIGS. 1(a) and 1(b) display a representative set of high pressure polarization curves under hydrogen/air and hydrogen/oxygen conditions for pure Pt thin film cathode layers with various Pt loadings. The cell temperature was 70° C., anode and cathode humidifier temperatures were 70° C. and 65° C., and stoichiometries were 1.5/2.0 at 1000 mA/cm², respectively. MEA performance generally increased with increasing Pt loadings. FIGS. 2(a) and 2(b) display the corresponding Tafel curves for the polarization curves shown in FIG. 1.

The Tafel plots show that losses due to concentration overpotential are significant under air operation. The higher concentration overpotentials can be attributed to the significant differences between the morphology of the decal to that of the traditional powder based electrocatalyst layers. The MEAs were cycled from open circuit voltage (OCV) to a specified current density for each condition. It should be noted that selection of the upper limit of current density for each condition appeared to influence performance.

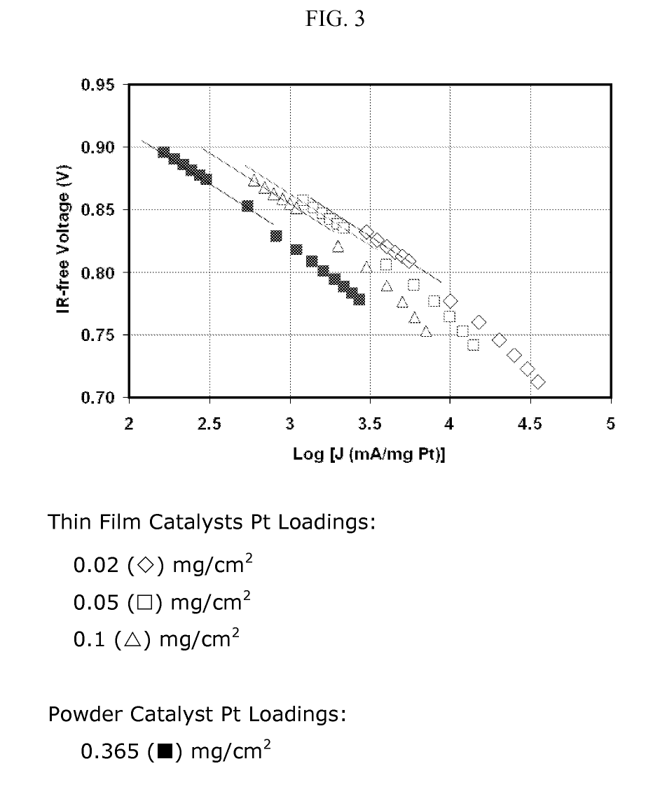

The mass performance of the pure Pt cathode films in relation to a MEA constructed utilizing traditional carbon supported Pt catalysts under oxygen at 150 kPa is displayed in FIG. 3. The powder MEA was constructed utilizing the presently disclosed decal method with 40% Pt on Vulcan XC-72R carbon with a dried Nafion® to Pt ratio of 0.5 to 1 by weight with a total cathode Pt loading of 0.365 mg/^{c}m². The anode was the same as that utilized in the thin film tests. Although the overall performance of the thin film MEAs was lower than that of MEAs utilizing powder catalysts, the mass performance is quite high indicating an increase in catalyst utilization with the thin films. Similar Tafel slopes were found for these MEAs as displayed by the parallel lines in FIG. 3.

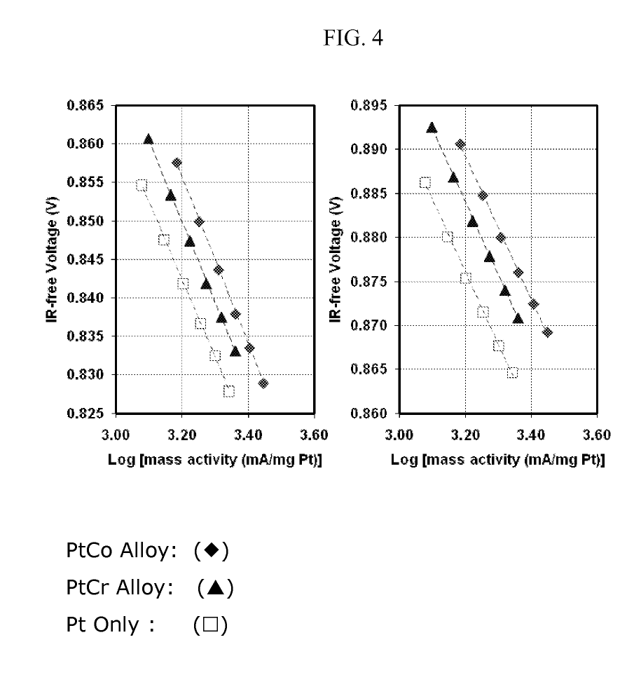

Testing was also performed for platinum cobalt (PtCo) and platinum chromium (PtCr) alloy films. PtCo and PtCr alloy films were deposited with a total metal loading target of 0.05 mg/cm² for comparison with a pure Pt MEA with a loading of 0.05 mg/cm². Overall, the alloy thin films displayed very similar performance curve features to the pure Pt showing similar trends in voltage and concentration polarization. However, the amount of Pt in the alloys is reduced (0.039 mg/cm² and 0.048 mg/cm² for the PtCo and PtCr alloys, respectively) resulting in an improved mass activity for the alloys. FIGS. 4(a) and 4(b) display the mass performance (Pt basis) of the alloys in comparison to pure Pt under hydrogen/air and hydrogen/oxygen operation in the Tafel region, respectively. Curve shifts up indicate higher activity towards the oxygen reduction reaction. The relative activity of the alloys compared to that of pure Pt was determined using IR-free voltage (current interrupt method) and high voltages to eliminate ohmic differences between the MEAs and to minimize or eliminate concentration polarization. Mass based performance improvements of 14 mV and 8 mV were obtained for PtCo and PtCr films in comparison to a pure Pt film under the testing conditions. Approximately 20 mV shifts were previously reported for powder based PtCo and PtCr catalysts, see T. R. Ralph and M. P. Hogarth, Platinum Metals Rev. 46, 3 (2002).

The similarity in performance improvements between thin film and supported powder catalysts allows for measurement of relative mass activities in comparison to pure Pt without the necessity to fabricate carbon supported nanoparticles.

The performance of PEMFCs with sputter deposited Pt, PtCr (80:20), and PtCo (76:24) cathode catalysts were assessed to determine the feasibility of utilizing thin film fabrication techniques to reduce Pt loading through better Pt utilization and use of more active Pt alloys easily produced using the thin film technology.

All publications, articles, papers, patents, patent publications, and other references cited herein are hereby incorporated herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The examples are presented to provide a more complete understanding of the present teachings. The specific techniques, conditions, materials, and reported data set forth to illustrate the principles of the principles of the present teachings are exemplary and should not be construed as limiting the scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the claims and their equivalents.

TABLE 1
Deposition Parameters and ICP-OES Results

| | Deposition | | | | | |
|---|---|---|---|---|---|---|
| | Power (W) | | | Deposition Time | Total Loading | Pt:M Ratio |
| Film | Pt | Co | Cr | (Seconds) | (mg/cm²) | (at %) |
| 1 | 30 | | | 8747 | 0.1 | |
| 2 | 30 | | | 4389 | 0.05 | |
| 3 | 30 | | | 1645 | 0.02 | |
| 4 | 30 | 56 | | 3801 | 0.043 | 76:24 |
| 5 | 30 | | 50 | 4401 | 0.051 | 80:20 |

What we claim is:

1. A method of preparing a membrane thin film electrode assembly comprising:
providing a composition comprising a support material and an ionomer component;
providing a carrier film substrate comprising at least two faces;
applying the composition onto at least one face of the carrier film substrate;
drying the composition to provide a dried composition;
sputtering a metal or metal alloy onto the dried composition to provide a film of dispersed metal or metal alloy;
removing a decal comprising a first face of dried composition and a second face of the film of dispersed metal or metal alloy from the one face of the carrier film substrate;
providing a polymer electrolyte membrane with two opposing faces;
contacting the second face of the film of dispersed metal or metal alloy on the decal to a first face of the polymer electrolyte membrane; and
hot pressing the decal onto the polymer electrolyte membrane to form a membrane thin film electrode assembly.

2. The method according to claim 1, further comprising
providing a gas diffusion layer;
contacting the gas diffusion layer with the first face of the decal;
providing a gas diffusion electrode;
contacting the gas diffusion electrode to the second face of the polymer electrolyte membrane; and
hot pressing the gas diffusion electrode to the second face of the polymer electrolyte membrane to form a full cell membrane thin film electrode assembly.

3. The method according to claim 1, wherein the sputtering of the metal or metal alloy occurs at pressures greater than about 10 mTorr Ar.

4. The method according to claim 1, wherein the support material comprises carbon black.

5. The method according to claim 1, wherein the ionomer component comprises at least one member selected from the group consisting of perfluorocarbon sulfonic acidic polymer, perfluorocarbon phosphonic acidic polymer, and trifluorostyrene sulfonic acidic polymer.

6. The method according to claim 1, wherein the metal comprises at least one member selected from the group consisting of iron, cobalt, nickel, copper, ruthenium, rhodium, palladium, silver, and platinum.

7. The method according to claim 1, wherein the metal comprises platinum.

8. The method according to claim 1, wherein the metal alloy comprises platinum and at least one member selected from the group consisting of titanium, vanadium, chromium, manganese, iron, cobalt, nickel, copper, zinc, selenium, molybdenum, ruthenium, rhodium, palladium, silver, tungsten, rhenium, iridium, and gold.

9. The method according to claim 1, wherein the metal alloy comprises platinum and at least one member selected from the group consisting of chromium and cobalt.

10. The method according to claim 1, wherein hot pressing comprises exposing the decal and the polymer electrolyte membrane to temperatures ranging between about 90 to 150 C and loads ranging between about 30 to 50 MPa.

11. The method according to claim 2, wherein hot pressing comprises exposing the gas diffusion electrode and the polymer electrolyte membrane to temperatures ranging between about 90 to 150 C and loads ranging between about 30 to 50 MPa.

12. The method according to claim 1, wherein the carrier film substrate comprises a substrate comprised of at least one member selected from the group consisting of silicone coated Mylar®, expanded porous polytetrafluoroethylene, porous polyethylene, porous polypropylene, non-porous ethylene tetrafluoroethylene, polytetrafluoroethylene, and polyethylene terephthalate.

13. A thin film electrocatalyst comprising:
a decal comprising a composition of a support material and an ionomer component, and a thin film of a metal or metal alloy catalyst sputtered onto the composition; and
a polymer electrolyte membrane,
wherein the thin film of a metal or metal alloy is in direct contact with the polymer electrolyte membrane.

14. A membrane electrode assembly comprising:
a polymer electrolyte membrane comprising a first face and a second opposing face;
a gas diffusion electrode;
a thin film electrode; and
a gas diffusion layer,
wherein the gas diffusion electrode is in contact with the first face of the polymer electrolyte membrane, and the thin film electrode is in contact with the second face of the polymer electrolyte membrane,
wherein the thin film electrode is sandwiched between the second face of the polymer electrolyte membrane and the gas diffusion layer, and
wherein the thin film electrode comprises a decal comprising a composition of a support material and an ionomer component, and a thin film of a metal or metal alloy catalyst sputtered onto the composition; and the thin film of a metal or metal alloy catalyst is in direct contact with the second face of the polymer electrolyte membrane.

15. The membrane electrode assembly according to claim 14, wherein the support material comprises carbon black.

16. The membrane electrode assembly according to claim 14, wherein the ionomer component comprises at least one member selected from the group consisting of perfluorocarbon sulfonic acidic polymer, perfluorocarbon phosphonic acidic polymer, and trifluorostyrene sulfonic acidic polymer.

17. The membrane electrode assembly according to claim 14, wherein the metal comprises at least one member selected from the group consisting of iron, cobalt, nickel, copper, ruthenium, rhodium, palladium, silver, and platinum.

18. The membrane electrode assembly according to claim 14, wherein the metal comprises platinum.

19. The membrane electrode assembly according to claim 14, wherein the metal alloy comprises platinum and at least one member selected from the group consisting of titanium, vanadium, chromium, manganese, iron, cobalt, nickel, copper, zinc, selenium, molybdenum, ruthenium, rhodium, palladium, silver, tungsten, rhenium, iridium, and gold.

20. The membrane electrode assembly according to claim 14, wherein the metal alloy comprises platinum and at least one member selected from the group consisting of chromium and cobalt.
